(19) United States
(12) Patent Application Publication
(10) Pub. No.: US 2013/0197672 A1
(43) Pub. Date: Aug. 1, 2013

(54) Pass-Through Controller for Cascaded Proportional-Integral-Derivative Control Loops

(71) Applicant: Probal Mitra, Mountain View, CA (US)

(72) Inventor: Probal Mitra, Mountain View, CA (US)

(73) Assignee: Intuitive Surgical Operations, Inc., Sunnyvale, CA (US)

(21) Appl. No.: 13/358,735

(22) Filed: Jan. 26, 2012

(51) Int. Cl. G05B 13/02

(52) U.S. Cl. 700/8; 700/42

(57) ABSTRACT

A cascade control system includes pass-through controller and a Proportional-Integral-Derivative (PID) controller, wherein the PID controller controls a first output of a device to generate an input to drive the device. The pass-through controller provides a setpoint to the PID controller and controls a second output of the device. The first output and optionally also a derivative of the first output is passed to the pass-through controller so that a pass-through control algorithm can be implemented that results in the input to the device only having terms of the second output, thereby avoiding dynamic interaction between the control loops of the pass-through controller and the PID controller.

### FIELD OF THE INVENTION

The present invention generally relates to control systems and in particular, to a pass-through controller for cascaded Proportional-Integral-Derivative (PID) control loops.

### BACKGROUND

Cascade control systems include multiple control loops for controlling multiple outputs of a device. As an example, FIG. 1 illustrates a block diagram for a cascade control system 100 including an inner controller 130 for controlling a sensed first output yₒᵤₜ of a device 140 and an outer controller 120 for controlling a sensed second output xₒᵤₜ of the device 140. In particular, the inner controller 130 controls an inner or secondary control loop 102 by zeroing a difference yₑᵣᵣ between a desired first output y_{des} and the sensed first output yₒᵤₜ. The outer controller 120 controls an outer or primary control loop 101 by zeroing a difference xₑᵣᵣ between a desired second output x_{des} and the sensed second output xₒᵤₜ. The outer controller 120 is coupled to the second controller 130 by providing the desired first output y_{des} as a setpoint for the inner controller 130. The first and second sensed outputs, yₒᵤₜ and xₒᵤₜ, are provided by sensors coupled to the device 140 (and shown for convenience herein as being part of the device 140). The device 140 may be any controllable mechanism such as a robotic arm or manipulator, a robotically manipulated device, or any other controllable component such as a motor. The sensed first output yₒᵤₜ may be a force or torque exerted by the controlled device and the sensed second output xₒᵤₜ may be a position of the controlled device.

In order to avoid undesirable dynamic interaction between the primary and secondary control loops, 101 and 102, the primary control loop 101 is typically tuned to be significantly slower than the secondary control loop 102. Dynamic interaction may be undesirable, for example, if the dynamic interaction results in excessive oscillations or instability in the cascade control system 100.

In certain applications, limiting the response time of the primary control loop 101 so that it is significantly slower than that of the secondary control loop 102 may result in an unacceptable degradation in the primary loop's performance. In these applications, in order to avoid potential problems with the dynamic interaction between the primary and secondary control loops, a cascade control system may be avoided entirely by using a different control system scheme.

As an example of a different control scheme, a hybrid position/force control system 200 as shown in FIG. 2 may be used for selectively controlling degrees of freedom of the device 140 using one or the other of a force control law 220 and a position control law 230, as determined by complementary matrices, S′ 221 and S 231, whose values are defined by system constraints. In this case, the force control law zeroes an error between a desired first output y_{des} and a sensed first output yₒᵤₜ. The position control law zeroes an error between a desired second output x_{des} and a sensed second output xₒᵤₜ. The input u, which is used to drive the device 140, is generated from a sum of the outputs of the complementary matrices, S′ 221 and S 231. Additional details for such a hybrid position/force control system are described in Craig, John J., Introduction to Robotics: Mechanics and Control, 2^{nd} Edition, Addison-Wesley Publishing Company, Inc., 1989, pp. 378-381.

Another technique that may be used to avoid having to limit the operating frequency of the primary loop to something which is less than a desirable rate is to effectively eliminate the secondary loop by disconnecting its feedback, so that only the outer control loop remains. This approach, however, is undesirable where the inner control loop must be kept active at times. It also may not be commercially practical where the inner control loop already exists in an application and the primary loop is being subsequently added to control the primary loop variable.

### OBJECTS AND SUMMARY

Accordingly, one object of one or more aspects of the present invention is a cascade control system in which the response time for a primary control loop is not constrained to be substantially less than that of a secondary control loop.

Another object of one or more aspects of the present invention is a pass-through controller which defines a setpoint for a Proportional-Integral-Derivative (PID) controller without control loops of the pass-through and PID controllers dynamically interacting with each other.

These and additional objects are accomplished by the various aspects of the present invention, wherein briefly stated, one aspect is a cascade control system comprising: a Proportional-Integral-Derivative (PID) controller that is configured to control a first output of a device according to a desired first output of the device; and a pass-through controller that is configured to generate the desired first output by controlling a second output of the device according to a desired second output of the device, wherein the pass-through controller includes a first path to which the first output is added to generate the desired first output.

Another aspect is a method for providing cascaded control about a Proportional-Integral-Derivative (PID) controller which is configured to generate an input to drive a device at least partially by controlling a first output of the device according to a desired first output of the device, the method comprising: generating the desired first output by applying a desired second output of the device and a second output of the device to a first function and adding the first output to a result of the first function.

Additional objects, features and advantages of the various aspects of the present invention will become apparent from the following description which should be taken in conjunction with the accompanying drawings.

### BRIEF DESCRIPTION OF THE DRAWINGS

FIG. 1 illustrates a block diagram of a conventional cascade control system.

FIG. 2 illustrates a block diagram of a conventional hybrid position/force control system as an alternative to cascade control.

FIG. 3 illustrates a block diagram of a cascade control system utilizing aspects of the present invention.

FIG. 4 illustrates a block diagram of a preferred PID controller included in a cascade control system utilizing aspects of the present invention.

FIG. 5 illustrates a block diagram of an alternative PID controller included in a cascade control system utilizing aspects of the present invention.

FIG. 6 illustrates a block diagram of a first embodiment of a pass-through controller included in a cascade control system utilizing aspects of the present invention.

FIG. 7 illustrates a block diagram of a second embodiment of a pass-through controller included in a cascade control system utilizing aspects of the present invention.

FIG. 8 illustrates a block diagram of a third embodiment of a pass-through controller included in a cascade control system utilizing aspects of the present invention.

FIG. 9 illustrates a block diagram of a fourth embodiment of a pass-through controller included in a cascade control system utilizing aspects of the present invention.

FIG. 10 illustrates a block diagram of a fifth embodiment of a pass-through controller included in a cascade control system utilizing aspects of the present invention.

FIG. 11 illustrates a block diagram of a chain of pass-through controllers included in a cascade control system utilizing aspects of the present invention.

### DETAILED DESCRIPTION

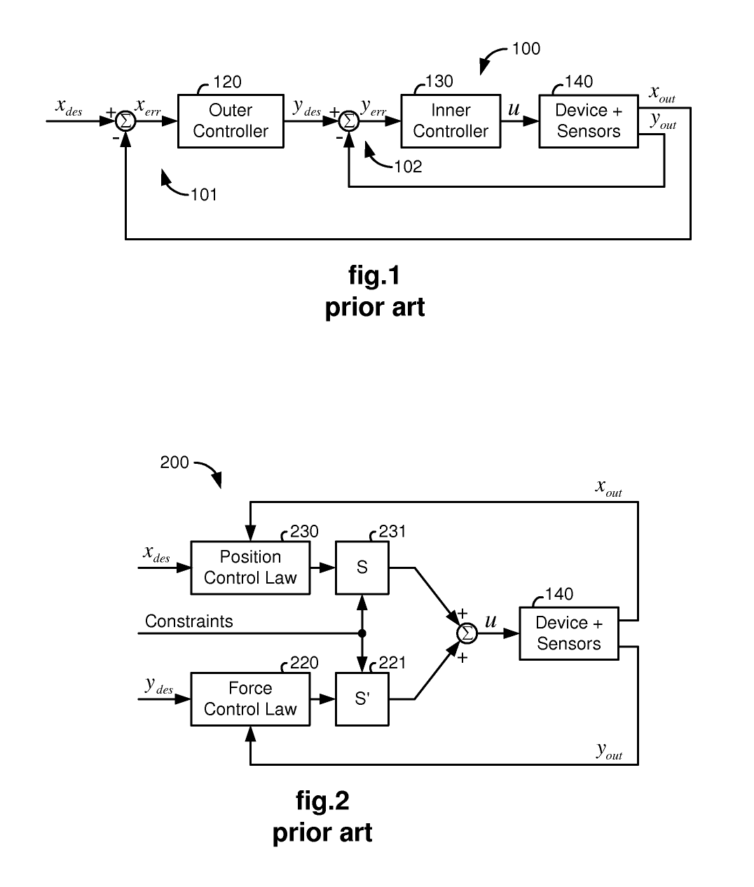

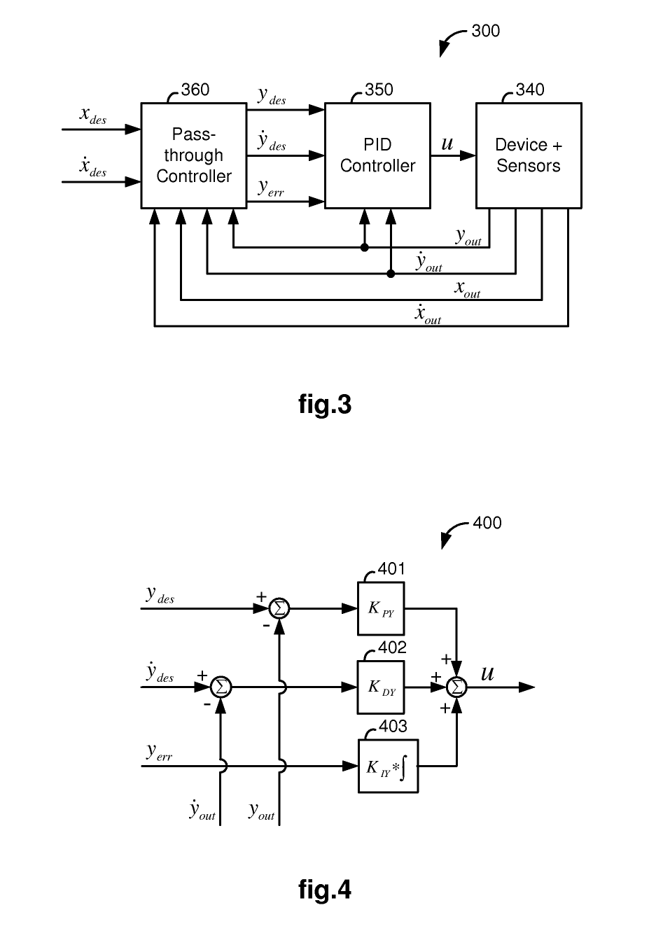

FIG. 3 illustrates, as an example, a block diagram of a cascade control system 300 comprising a Proportional-Integral-Derivative (PID) controller 350 and a pass-through controller 360. In this example, the device 340 comprises a motor driven grip mechanism that takes an electrical current command as an input (u) and produces an angular torque (yₒᵤₜ) and an angular position (xₒᵤₜ) as first and second outputs. In other examples, the device 340 may be any controllable device such as the device 140 of FIG. 1. The device 340 is coupled to a sensor for sensing the angular torque (\dot{y}ₒᵤₜ) and a sensor for sensing the angular position (\dot{x}ₒᵤₜ). In addition, the device 340 may also be coupled to a sensor for sensing an angular torque velocity (\dot{y}ₒᵤₜ) and a sensor for sensing the angular velocity (\dot{x}ₒᵤₜ). Alternatively, rather than providing sensors for the angular torque velocity (\dot{y}ₒᵤₜ) and the angular velocity (\dot{x}ₒᵤₜ), these velocities may be computed as derivatives of the sensed angular torque (yₒᵤₜ) and sensed angular position (xₒᵤₜ). To simplify the description herein, all such sensors are shown in FIG. 3 as being part of the device 340. However, it is to be appreciated that individual, or even all, of the sensors may be separate components from the device 340.

FIG. 4 illustrates, as an example, a block diagram of a preferred embodiment 400 of the PID controller 350, whose control algorithm is provided in equation (1) below for the input (u):

u=K_{py}(y_{des}−yₒᵤₜ)+K_{DY}(\dot{y}_{des}−\dot{y}ₒᵤₜ)+K_{IY}∫(yₑᵣᵣ)dt (1)

where y_{des} is a desired angular torque that serves as a setpoint for the PID controller 400; \dot{y}^{des} is a desired angular torque velocity; yₒᵤₜ is the sensed angular torque; \dot{y}ₒᵤₜ is the sensed or computed angular torque velocity; yₑᵣᵣ is an angular torque error; and K_{PY}, K_{DY}, and K_{IY} are tunable gains respectively for the proportional, derivative, and integral functions 401, 402, and 403.

The PID controller 400 provides the flexibility to accept not only the setpoint yₒᵤₜ as input, but also the desired angular torque velocity \dot{y}_{des} and the torque error yₑᵣᵣ as inputs. Traditional PID controllers, on the other hand, are generally more restrictive and typically only accept the desired angular torque yₒᵤₜ as an input with the desired angular torque velocity \dot{y}_{des} calculated as a derivative of the desired angular torque yₒᵤₜ over time and the torque error yₑᵣᵣ calculated as a difference between the desired angular torque \dot{y}_{des} and the sensed angular torque yₒᵤₜ.

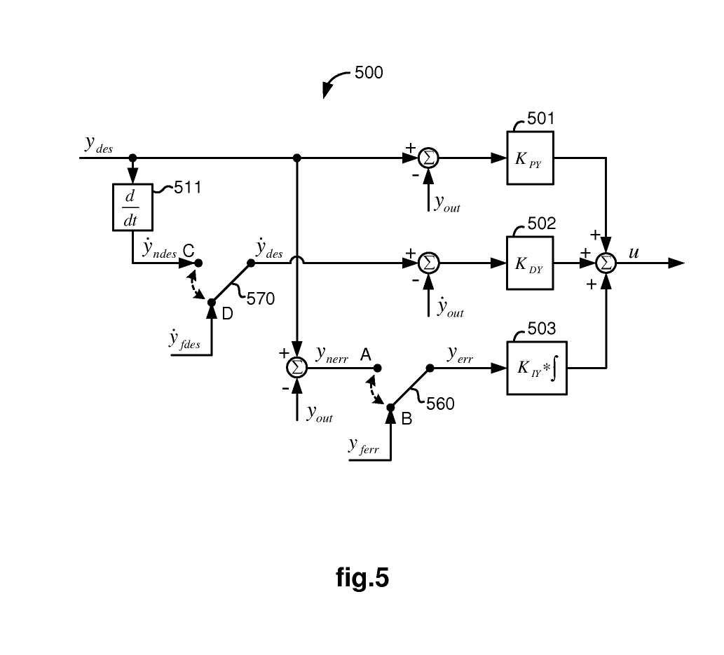

FIG. 5 illustrates, as an example, a block diagram of an alternative embodiment 500 of the PID controller 350. This embodiment extends a traditional PID controller by adding switches 560 and 570 which facilitate either using conventionally determined values for the desired angular torque velocity \dot{y}_{des} and the angular torque error yₑᵣᵣ with forced values that over-ride these determined values with other defined values or functions. Switch 560 has two switch positions, A and B. In switch position A, a conventional value yₙₑᵣᵣ (i.e., y_{des}−yₒᵤₜ) for the angular torque error yₑᵣᵣ is provided as an input to the integral function 503. In switch position B, however, a forced value y_{ferr} for the angular torque error yₑᵣᵣ is provided instead. Switch 570 also has two switch positions, C and D. In switch position C, a conventional value \dot{y}_{ndes} (i.e.,

$$\frac{d {y}_{des}}{d t} ,$$

as calculated using derivative function 511) for the desired angular torque velocity \dot{y}_{des} is used to generate an input (i.e., \dot{y}_{des}−\dot{y}ₒᵤₜ) to the derivative function 502. In switch position D, however, a forced value \dot{y}_{fdes} is used instead for the desired angular torque velocity \dot{y}_{des} to generate the input to derivative function 502. The control law for the PID controller 500 is the same as equation (1) with K_{PY}, K_{DY}, and K_{IY} also being tunable gains respectively for the proportional, derivative, and integral functions 501, 502, and 503.

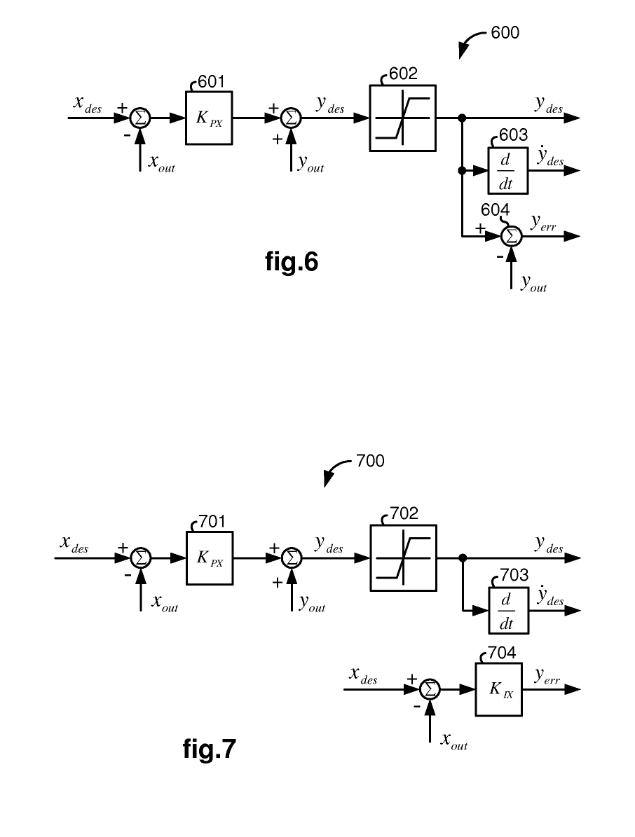

FIG. 6 illustrates, as an example, a first embodiment 600 of the pass-through controller 360, which comprises a proportional path in which the sensed angular torque yₒᵤₜ is added according to the following equation (2) for the setpoint y_{des} for the PID controller 350:

y_{des}=K_{PX}(x_{des}−xₒᵤₜ)+yₒᵤₜ (2)

where x_{des} is a desired angular position; xₒᵤₜ is the sensed angular position; yₒᵤₜ is the sensed angular torque; and K_{PX} is a tunable gain for the proportional function 601.

A limiter function 602 is also included in the pass-through controller 600. The limiter function 602 limits the setpoint y_{des} to be within specified torque limits for the motor driven grip mechanism of the device 340. The limiter function 602 serves to implement force-limited motion control of the grip mechanism. In the absence of large forces (e.g., when moving the grip mechanism without closing them completely or hitting any obstacles) the cascade control system 300 converts desired angular position commands for the grip mechanism into motor torque commands so that the motor driven grip mechanism accurately tracks a given desired angular position x_{des}. When large forces are sensed (where “large” means beyond a prescribed threshold so as to saturate the limiter function 602) acting against the grip mechanism, the cascade control system 300 effectively switches to force control, where it directly adjusts motor torque for the grip mechanism in order to keep the sensed force level at the prescribed threshold (i.e., “overforce protection”). The cascade control system 300 thus ensures that force levels in the motor driven grip mechanism remain within safe limits while still allowing accurate opening and closing of the grip mechanism.

A derivative function 603 and a summing node 604 are also included in the pass-through controller 600. These components are used to calculate a desired angular torque velocity \dot{y}_{des} and an angular torque error yₑᵣᵣ according to the following equations (3) and (4):

\dot{y}_{des}=K_{PX}(\dot{x}_{des}−\dot{x}ₒᵤₜ)+\dot{y}ₒᵤₜ (3)

yₑᵣᵣ=y_{des}−yₒᵤₜ

where \dot{x}_{des} is a desired angular velocity (which may be provided as an input as shown in FIG. 3 or calculated as the derivative of x_{des}); \dot{x}ₒᵤₜ is the sensed or computed angular velocity; \dot{y}ₒᵤₜ is the sensed or computed angular torque velocity; y_{des} is the setpoint for the PID controller 350; yₒᵤₜ is the sensed angular torque; and K_{PX} is the tunable gain for the proportional function 601.

It is noteworthy to point out that if the alternative PID controller 500 is used for the PID controller 350, then the desired angular torque velocity \dot{y}_{des} and the angular torque error yₑᵣᵣ would be computed in the PID controller 500 rather than the pass-through controller 600. In that case, the derivative function 603 and the summing node 604 may be omitted and switches 560 and 570 of the PID controller 500 would respectively be placed in their A and C positions.

The usefulness of the pass-through controller 600 is appreciated by substituting equations (2), (3) and (4) into equation (1) to obtain the following equation (5) for the input (u):

U=K_{PY}K_{PX}(x_{des}−xₒᵤₜ)+K_{DY}K_{PX}(\dot{x}_{des}−\dot{x}ₒᵤₜ)+K_{IY}K_{PX}∫(x_{dex}−xₒᵤₜ)dt (5)

Thus, the combination of the pass-through controller 600 and the PID controller 350 now appears as a single proportional-integral-derivative control algorithm for the angular position and velocity terms (e.g., x_{des}, xₒᵤₜ, \dot{x}_{des}, \dot{x}ₒᵤₜ) with all angular torque terms (e.g., y_{des}, yₒᵤₜ, \dot{y}_{des}, \dot{y}ₒᵤₜ) eliminated. Consequently, there is no dynamic interaction problem between the pass-through controller 360 and the PID controller 350.

However, the pass-through controller 600 only provides one tunable gain, K_{PX}, since the gains K_{PY}, K_{DY} and K_{IY} for the PID controller 350 are tuned for the PID controller 350 and it would be undesirable to change them. Although this may provide satisfactory results in some applications, if tuning of the derivative and/or integral path gains is desired, then an alternative embodiment for the pass-through controller 360 may be used.

FIG. 7 illustrates, as an example, a second embodiment 700 of the pass-through controller 360, which comprises a proportional path and an integral path according to the following equations (6) and (7) respectively for the setpoint y_{des} and forced angular torque error yₑᵣᵣ:

y_{des}=K_{PX}(x_{des}−xₒᵤₜ)+yₒᵤₜ (6)

yₑᵣᵣ=K_{IX}(x_{des}−xₒᵤₜ) (7)

where x_{des} is the desired angular position; xₒᵤₜ is the sensed angular position; yₒᵤₜ is the sensed angular torque; and K_{PX} and K_{IX} are tunable gains for the proportional and integral functions 701 and 704.

A limiter function 702 and a derivative function 703 are also included in the pass-through controller 700 and perform the same functions as their counterparts 602 and 603 as described in reference to the pass-through controller 600 of FIG. 6. In this case, the equation for the desired angular torque velocity \dot{y}_{des} is the same as equation (3) above.

The usefulness of the pass-through controller 700 is appreciated by substituting equations (6), (7) and (3) into equation (1) to obtain the following equation (8) for the input (u):

u=K_{PY}K_{PY}(x_{des}−xₒᵤₜ)+K_{DY}K_{PX}(\dot{x}_{des} −\dot{x}ₒᵤₜ)+K_{IY}K_{IX}∫(x_{des}−xₒᵤₜ)dt (8)

Thus, the combination of the pass-through controller 700 and the PID controller 350 appears as a single proportional-integral-derivative control algorithm for the angular position and velocity terms with all angular torque terms eliminated. Consequently, there is no dynamic interaction problem between the pass-through controller 360 and the PID controller 350.

However, the pass-through controller 700 only provides tunable gains for the proportional and integral paths, K_{PX} and K_{IX}, since the gains K_{PY}, K_{DY} and K_{IY} for the PID controller 350 are tuned for the PID controller 350 and it would be undesirable to change them. Although this may provide satisfactory results in some applications, if tuning of the derivative path gain is desired, then an alternative embodiment for the pass-through controller 360 may be used.

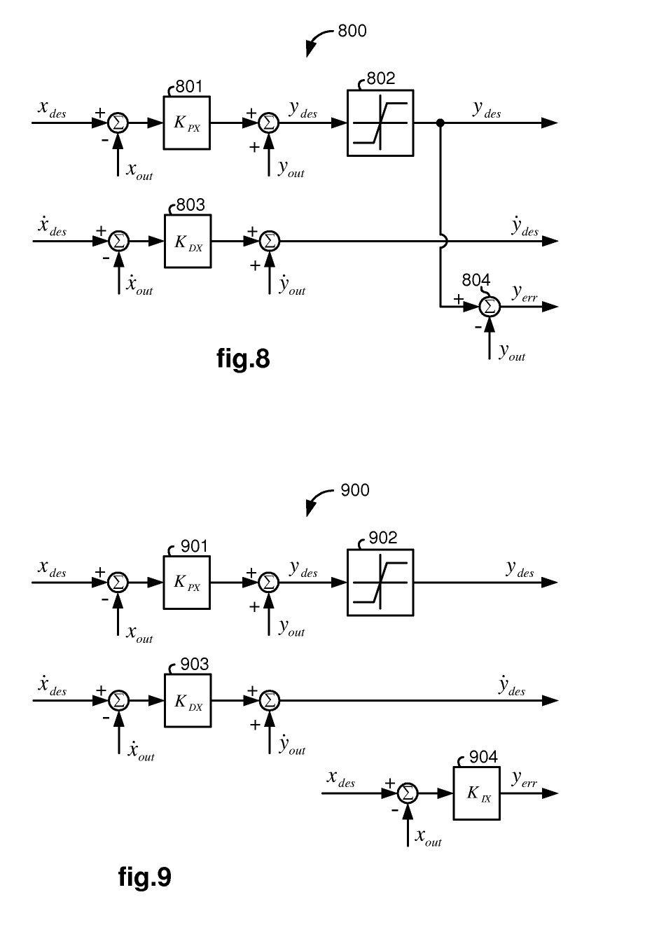

FIG. 8 illustrates, as an example, a third embodiment 800 of the pass-through controller 360, which comprises a proportional path and a derivative path according to the following equations (9) and (10) respectively for the setpoint y_{des} and forced angular torque velocity \dot{y}_{des}:

y_{des}=K_{PX}(x_{des}−xₒᵤₜ)+yₒᵤₜ (9)

\dot{y}^{des}=K_{DA}(\dot{x}_{des}−\dot{x}ₒᵤₜ)+\dot{y}ₒᵤₜ (10)

where x_{des} is the desired angular position, xₒᵤₜ is the sensed angular position; \dot{x}_{des} is a desired angular velocity (which may be provided as an input or calculated as the derivative of x_{des}); \dot{x}ₒᵤₜ is the sensed or computed angular velocity; yₒᵤₜ is the sensed angular torque; \dot{y}ₒᵤₜ is the sensed or computed angular torque velocity; and K_{PX} and K_{DX} are tunable gains for the proportional and derivative functions 801 and 803.

A limiter function 802 and a summing node 804 are also included in the pass-through controller 800 and perform the same functions as their counterparts 602 and 604 as described in reference to the pass-through controller 600 of FIG. 6. In this case, the equation for the angular torque error yₑᵣᵣ is the same as equation (4) above.

The usefulness of the pass-through controller 800 is appreciated by substituting equations (9), (10) and (4) into equation (1) to obtain the following equation (11) for the input (u):

u=K_{PY}K_{PX}(x_{des}−xₒᵤₜ)+K_{DY}K_{DX}(\dot{x}_{des}−\dot{x}ₒᵤₜ)+K_{IY}K_{PX}∫(x_{des}−xₒᵤₜ)dt

Thus, the combination of the pass-through controller 800 and the PID controller 350 appears as a single proportional-integral-derivative control algorithm for the angular position and velocity terms with all angular torque terms eliminated. Consequently, there is no dynamic interaction problem between the pass-through controller 360 and the PID controller 350.

However, the pass-through controller 800 only provides tunable gains for the proportional and derivative paths, K_{PX} and K_{DX}, since the gains K_{PY}, K_{DY} and K_{IY} for the PID controller 350 are tuned for the PID controller 350 and it would be undesirable to change them. Although this may provide satisfactory results for some applications, if tuning of the integral path gain is also desired, then an alternative embodiment for the pass-through controller 360 may be used.

FIG. 9 illustrates, as an example, a fourth embodiment 900 of the pass-through controller 360, which comprises a proportional path, a derivative path, and an integral path according to the following equations (12), (13) and (14) respectively for the setpoint y_{des}, forced angular torque velocity \dot{y}_{des}, and forced angular torque error yₑᵣᵣ:

y_{des}=K_{PX}(x_{des}−xₒᵤₜ)+yₒᵤₜ (12)

\dot{y}_{des}=K_{DX}(\dot{x}_{des}−\dot{x}ₒᵤₜ)+\dot{y}ₒᵤₜ (13)

yₑᵣᵣ=K_{IX}(x_{des}−xₒᵤₜ) (14)

where x_{des} is the desired angular position; xₒᵤₜ is the sensed angular position; \dot{x}_{des} is a desired angular velocity (which may be provided as an input or calculated as the derivative of x_{des}); \dot{x}ₒᵤₜ is the sensed or computed angular velocity; yₒᵤₜ is the sensed angular torque; \dot{y}ₒᵤₜ is the sensed or computed angular torque velocity; and K_{PX}, K_{DX} and K_{IX} are tunable gains for the proportional, derivative and integral functions 901, 903 and 904.

A limiter function 902 is also included in the pass-through controller 900 and performs the same function as its counterpart 602 as described in reference to the pass-through controller 600 of FIG. 6.

The usefulness of the pass-through controller 900 is appreciated by substituting equations (12), (13) and (14) into equation (1) to obtain the following equation (15) for the input (u):

u=K_{PY}K_{PX}(x_{des}−xₒᵤₜ)+K_{DY}K_{DX}(\dot{x}_{des}−\dot{x}ₒᵤₜ)+K_{IY}K_{IX}∫(x_{des}−xₒᵤₜ)dt (15)

Thus, the combination of the pass-through controller 900 and the PID controller 350 appears as a single proportional-integral-derivative control algorithm for the angular position and velocity with all angular torque terms eliminated. Consequently, there is no dynamic interaction problem between the pass-through controller 360 and the PID controller 350. Further, the pass-through controller 900 provides tunable gains, K_{PX}, K_{DX} and K_{IX}, for the proportional, derivative and integral paths. Therefore the resulting PID control algorithm characterized by equation (15) is fully tunable as a conventional PID control system for desired dynamic characteristics.

Although simple gain values are used in the embodiments 600, 700, 800, and 900 of the pass-through controller 360, more complex gain functions may also be used in conjunction with the various aspects of the present invention.

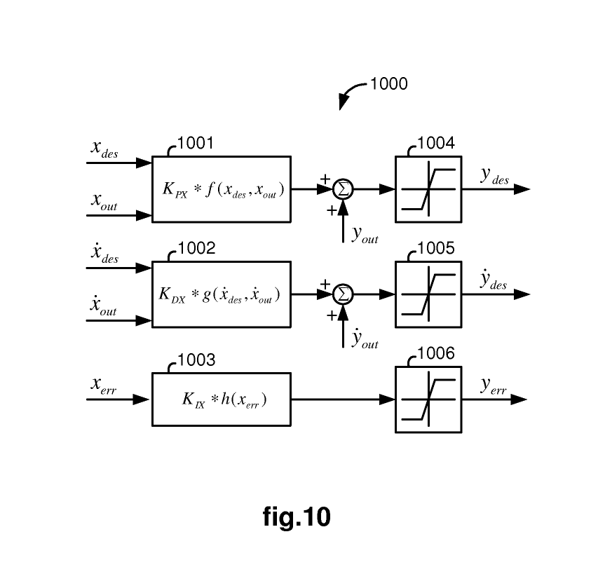

FIG. 10 illustrates, as an example, a fifth embodiment 1000 of the pass-through controller 360, which comprises a proportional path, a derivative path, and an integral path according to the following equations (16), (17) and (18) respectively for the setpoint (desired angular torque) y_{des}, forced angular torque velocity \dot{y}_{des}, and forced angular torque error yₑᵣᵣ:

y_{des}=K_{PX}*f(x_{des}, xₒᵤₜ)+yₒᵤₜ (16)

\dot{y}_{des}=K_{PX}*g(\dot{x}_{des}, \dot{x}ₒᵤₜ)+\dot{y}ₒᵤₜ (17)

yₑᵣᵣ=K_{IX}*h(xₑᵣᵣ) (18)

where x_{des} is the desired angular position; xₒᵤₜ is the sensed angular position; \dot{x}_{des} is a desired angular velocity (which may be provided as an input or calculated as the derivative of x_{des}); \dot{x}ₒᵤₜ is the sensed or computed angular velocity; xₑᵣᵣ is an angular position error; yₒᵤₜ is the sensed angular torque; \dot{y}ₒᵤₜ is the sensed or computed angular torque velocity; K_{PX}*f(x_{des}, xₒᵤₜ), K_{PX}*g(\dot{x}_{des}, \dot{x}ₒᵤₜ), and K_{IX}*h(xₑᵣᵣ) are proportional, derivative and integral functions 1001, 1002 and 1003; and K_{PX}, K_{DX} and K_{IX} are tunable gains for the proportional, derivative and integral functions.

A limiter function 1004 is also included in the pass-through controller 1000 and performs the same function as its counterpart 602 as described in reference to the pass-through controller 600 of FIG. 6. Limiters 1005 and 1006 may also be included that respectively limit the forced angular toque velocity \dot{y}_{des} and the forced angular torque error yₑᵣᵣ to desired ranges.

The usefulness of the pass-through controller 1000 is appreciated by substituting equations (16), (17) and (18) into equation (1) to obtain the following equation (19) for the input (u):

u=K_{PY}K_{PX}*f(x_{des}, xₒᵤₜ)+K_{DY}K_{DX}*g(\dot{x}_{des}, \dot{x}ₒᵤₜ)+K_{IY}K_{IX}∫*h(xₑᵣᵣ)dt (19)

Thus, the combination of the pass-through controller 1000 and the PID controller 350 appears as a single generic, non-linear control algorithm for the angular velocity terms with all angular torque terms eliminated. Consequently, there is no dynamic interaction problem between the pass-through controller 360 and the PID controller 350. Further, the pass-through controller 1000 provides tunable gains, K_{PX}, K_{DX}, and K_{IX}, respectively for the proportional, derivative, and integral paths. Therefore the resulting non-linear control algorithm characterized by equation (19) is fully tunable as a non-linear control system for desired dynamic characteristics. Still further, the pass-through controller 1000 provides functions f(x_{dex}, xₒᵤₜ), g(\dot{x}_{des}, \dot{x}ₒᵤₜ), and h(xₑᵣᵣ) for design flexibility in generating a linear or non-linear control law for the input (u).

A sixth embodiment of the pass-through controller 360 may also be constructed by modifying the first embodiment 600 by replacing block 601 of FIG. 6 with block 1001 of FIG. 10. A seventh embodiment of the pass-through controller 360 may also be constructed by modifying the second embodiment 700 by replacing blocks 701 and 704 of FIG. 7 respectively with blocks 1001 and 1003 of FIG. 10. An eighth embodiment of the pass-through controller 360 may also be constructed by modifying the third embodiment 800 by replacing blocks 801 and 803 of FIG. 8 respectively with blocks 1001 and 1002 of FIG. 10.

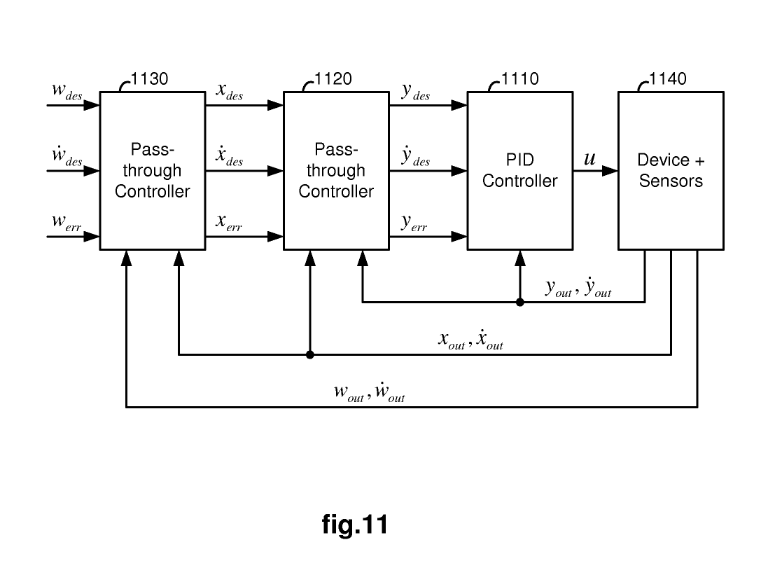

As can be appreciated, since the combination of the pass-through controller 360 and the PID controller 350 appears like a PID control system (for the first four embodiments described above), a second pass-through controller similar in construction to the pass-through controller 360 may be added to the cascade control system 300 to provide inputs x_{dex}, \dot{x}_{des}, and xₑᵣᵣ to the pass-through controller 360 while controlling a third output wₒᵤₜ and effectively resulting in a PID control system for the input (u) as a function of only the third output, as shown, for example, in FIG. 11. As can be further appreciated, additional pass-through controllers (e.g., third, fourth, and so on), each similar in construction to the pass-through controller 360, may sequentially be added to the cascade control system 300 to control additional outputs of the device and sensors 340 and effectively resulting in a PID control system for the input (u) as a function of only their respective outputs so as to avoid dynamic interaction with other control loops in the cascade control system. In generating such a cascade control system, it is to be noted that only the last pass-through controller may be implemented by one of the non-linear control algorithms of the fifth through eighth embodiments. All other pass-through controllers should be of the linear PID type of the first four embodiments.

FIG. 11 illustrates, as an example, a block diagram of a cascade control system 1100 including a PID controller 1110 (such as the PID controller 350) to control a first output yₒᵤₜ of the device 1140 (including for description purposes the output sensors) and generate an input u provided to the device 1140, a first pass-through controller 1120 (such as the pass-through controller 900 or any other linear PID type embodiment of the pass-through controller described herein which is appropriately modified) to control a second output xₒᵤₜ of the device and generate a setpoint y_{dex} for the PID controller 1110, and a second pass-through controller 1130 (such as the pass-through controller 900 or 1000 or any other embodiment of the pass-through controller described herein as appropriately modified if necessary) to control a third output wₒᵤₜ of the device and generate a setpoint x_{des} for the first pass-through controller 1120.

Although the various aspects of the present invention have been described with respect to one or more embodiments, it will be understood that the invention is entitled to full protection within the full scope of the appended claims.

What is claimed is:

1. A cascade control system comprising:
a Proportional-Integral-Derivative (PID) controller configured to generate an input to drive a device at least partially by controlling a first output of the device according to a desired first output of the device; and
a pass-through controller configured to generate the desired first output by controlling a second output of the device according to a desired second output of the device, wherein the pass-through controller includes a first path to which the first output is added to generate the desired first output.

2. The cascade control system of claim 1, wherein the first path includes a first function of the desired second output and the second output.

3. The cascade control system of claim 2, wherein the first function comprises a difference between the desired second output and the second output.

4. The cascade control system of claim 2, wherein the first function comprises a first tunable gain.

5. The cascade control system of claim 2, wherein the first path includes a limiter for limiting the desired first output to be within a desired range.

6. The cascade control system of claim 1, wherein the pass-through controller includes a second path to which a derivative of the first output is added to generate a derivative of the desired first output, and wherein the PID controller is configured to generate the input to drive the device at least partially by controlling the derivative of the first output according to the derivative of the desired first output.

7. The cascade control system of claim 6, wherein the second path includes a second function of a derivative of the desired second output and a derivative of the second output.

8. The cascade control system of claim 7, wherein the second function comprises a difference between the derivative of the desired second output and the derivative of the second output.

9. The cascade control system of claim 7, wherein the second function comprises a second tunable gain.

10. The cascade control system of claim 1, wherein the pass-through controller includes a third path including a third function of the desired second output and the second output to generate an error for the second output, and wherein the PID controller is configured to generate the input to drive the device at least partially by an integral of the error for the second output.

11. The cascade control system of claim 10, wherein the third function comprises a difference between the desired second output and the second output.

12. The cascade control system of claim 11, wherein the third function comprises a third tunable gain.

13. The cascade control system of claim 1, wherein the PID controller has a first input for receiving the desired first output of the device, a second input for receiving a forced derivative of the desired first output of the device, and a third input for receiving a forced error for the second output.

14. The cascade control system of claim 1, wherein the device is a controllable mechanism, the first output is a force exerted by the mechanism, and the second output is a position of the mechanism.

15. A method for providing cascaded control about a Proportional-Integral-Derivative (PID) controller which is configured to generate an input to drive a device at least partially by controlling a first output of the device according to a desired first output of the device, the method comprising:
generating the desired first output by applying a desired second output of the device and a second output of the device to a first function and adding the first output to a result of the first function.

16. The method of claim 15, wherein the first function comprises a difference between the desired second output and the second output.

17. The method of claim 15, wherein the first function comprises a first tunable gain.

18. The method of claim 15, wherein the generating of the desired first output comprises limiting the desired first output to be within a desired range.

19. The method of claim 15, wherein the PID controller is configured to generate the input to drive the device at least partially by controlling a derivative of the first output according to a derivative of the desired first output, and further comprising:
generating the derivative of the desired first output by applying a derivative of the second output of the device and a derivative of the second output of the device to a second function and adding the derivative of the first output to a result of the second function.

20. The method of claim 19, wherein the second function comprises a difference between the derivative of the desired second output and the derivative of the second output.

21. The method of claim 19, wherein the second function comprises a second tunable gain.

22. The method of claim 15, wherein the PID controller is configured to generate the input to drive the device at least partially by an integral of the error for the second output, and further comprising:
generating the error for the second output by applying the desired second output and the second output to a third function.

23. The method of claim 22, wherein the third function comprises a difference between the desired second output and the second output.

24. The method of claim 22, wherein the third function comprises a third tunable gain.
